(19) United States
(12) Patent Application Publication
(10) Pub. No.: US 2021/0206057 A1
(43) Pub. Date: Jul. 8, 2021

(54) THREE-DIMENSIONAL PRINTER WITH MOVEMENT DEVICE

(71) Applicant: HEWLETT-PACKARD DEVELOPMENT COMPANY, L.P., Spring, TX (US)

(72) Inventors: Wesley R. SCHALK, Vancouver, WA (US); Matthew A. SHEPHERD, Vancouver, WA (US)

(73) Assignee: HEWLETT-PACKARD DEVELOPMENT COMPANY, L.P., Houston, TX (US)

(21) Appl. No.: 16/075,504

(22) PCT Filed: Jul. 28, 2017
(86) PCT No.: PCT/US2017/044322

§ 371 Date: Aug. 3, 2018

(51) Int. Cl. B29C 64/165; B29C 64/241; B29C 64/209; B29C 64/268; B29C 64/236; B29C 64/218; B33Y 10/00; B33Y 30/00

(52) U.S. Cl. CPC B29C 64/165; B29C 64/241; B29C 64/209; B33Y 30/00; B29C 64/236; B29C 64/218; B33Y 10/00; B29C 64/268

(57) ABSTRACT

A three-dimensional (3D) printer and method including a movement device and an energy source. The energy source to apply energy to build material on a build platform.

### BACKGROUND

Additive manufacturing (AM) may include three-dimensional (3D) printing to form 3D objects. In particular, a 3D printer may add successive layers of build material, such as powder, to a build platform. The 3D printer may selectively solidify portions of each layer under computer control to produce the 3D object. The material may be powder, or powder-like materials, including metal, plastic, concrete, composite material, and other powders. The objects can be various shapes and geometries, and produced via a model such as a 3D model or other electronic data source. The fabrication may involve laser melting, laser sintering, electron beam melting, or thermal fusion, and so on. The model and automated control may facilitate the layered manufacturing and additive fabrication. As for printed products, AM may fabricate intermediate and end-use products, as well as prototypes.

### DESCRIPTION OF THE DRAWINGS

Certain examples are described in the following detailed description and in reference to the drawings, in which:

FIG. 1 is a block diagram of a 3D printer in accordance with examples of the present techniques;

FIG. 2 is a block diagram of a 3D printer in accordance with examples of the present techniques;

FIG. 3 is a block diagram of a 3D printer in accordance with examples of the present techniques;

FIG. 4 is a block diagram of a 3D printer in accordance with examples of the present techniques;

FIG. 5 is a schematic diagram of a 3D printer in accordance with examples of the present techniques;

FIG. 6 is a block flow diagram of a method of operating a 3D printer in accordance with examples of the present techniques; and

FIG. 7 is a block flow diagram of a method of operating a 3D printer in accordance with examples of the present techniques.

### DETAILED DESCRIPTION

A 3D printer may form a 3D object on a build platform from material such as powder. A powder spreader of the 3D printer may disperse build material across the build platform. To solidify or fuse the build material into the 3D object, the 3D printer may apply print liquid with a print assembly and apply energy with an energy source to the build material. The print liquid may be a fusing agent or other printing agent. In some examples, the print assembly may include a printbar having multiple print nozzles to eject the print liquid based on a 3d object model of an object to be generated. The print assembly may include two or more printbars. The energy source may be, for example, a light source or heat source. In certain examples, the energy source may apply energy substantially uniformly across the build material on the build platform. However, in some examples, the print liquid as a fusing agent may increase absorption of energy by the build material where the print liquid is applied.

The energy source and the print assembly may lose functionality as a result of their proximity to build material. In other words, such loss or degradation in functionality may occur due to occlusion and clogging of the energy source and the print assembly with build material emanating from the build platform or from a powder spreader. Further, the print assembly may lose functionality as a result of proximity to the energy source because residual heat from the energy source may degrade performance of a print assembly too close to the energy source. In addition, residual heat radiating from the build material on the build platform may degrade functionality of the print assembly. The exposure of the print assembly to heat may degrade print liquid or printing agent in the print assembly.

Examples of the present techniques are directed to a 3D printer having a print assembly located generally separate from the energy source. For example, the print assembly and energy source may reside on different movement devices that may move independently and also rest in different regions of the printer. Moreover, with the print assembly and energy source on different movement devices, the print assembly or the energy source may generally not spend significant time over the build platform when not in operation.

In some examples, the energy source and the powder spreader may share a first movement device that moves both the energy source and powder spreader over the build platform. The print assembly may reside on a second movement device which moves the print assembly over the build platform to eject print liquid onto selected portions of build material. Therefore, the print assembly may be generally separate and rest away from the energy source and powder spreader. The separation of the print assembly from the powder spreader may reduce clogging of the print assembly ejection nozzles. In an example, the second movement device may carry the energy source to apply energy to the build material on the build platform, wherein the second movement device to rest in a second parked position at an opposite edge region of the 3D printer as compared to the edge region of the first parked position. The edge region of the 3D printer may be a region near the outer perimeter of the 3D printer. In an example, when a movement device positions a print assembly or an energy source in an edge region of the first parked position, there may be no other components in a solid state of matter between the print assembly or energy source and the interior wall of the 3D printer. In an example, the first parked position may be out of direct line of sight of an overhead heating lamp. The overhead heating lamp may be matched in dimensions to the build platform area. In an example, an overhead heating lamp may warm a portion of the build platform where build material is present. In an example, the overhead heating lamp is parallel to the build platform and a distance away to allow a movement device such as a carriage carrying a print assembly to pass between the build platform and the overhead heating lamp. The second movement device may include a second parked position at an opposite end portion of the 3D printer than the parked position of the first movement device.

The print assembly being moved by the separate second movement device and not travelling with the energy source may reduce the time the print assembly is exposed to the build material over the build platform when the print assembly is not ejecting print liquid. Similarly, the energy source being disposed on the first movement device instead of on the second movement device with the print assembly, may reduce the time the energy source is over the build platform. In an example, the first movement device positions the print assembly over the build platform to eject the print liquid, where the first movement device rests in a first parked position away from the build platform to reduce exposure of the print assembly to the build material and to the energy source. In an example, a parked position may not overlap with the area over the build platform. In an example, the parked position may be a location a movement device may be positioned in order to position the print assembly in an area that is not overlapping with the area above the build platform.

An example of a 3D printer has an outer housing and a cartridge receiver integrated with the 3D printer at least partially within the outer housing. The cartridge receiver may hold a removable material cartridge to make material available from the material cartridge as build material for printing. The 3D printer may include a conveying system, such as a pneumatic conveyance system, to transport the build material to the powder spreader or build platform.

Further, the 3D printer may include a build enclosure associated with the build platform. The build enclosure may be a build bucket, build container, or build chamber, and the like. As indicated, the 3D printer may have an internal conveying system to transport build material to feed equipment for the build enclosure and build platform. The conveying system may deliver the build material to a selective solidification module or thermal fusion system disposed at least partially above the build enclosure. The thermal fusion system may include movement devices or carriages to carry and move the aforementioned energy source, and print assembly. In some examples, the build-material applicator or powder spreader is not a component of the thermal fusion system. In other examples, the thermal fusion system includes the build-material applicator or powder spreader. The build platform may receive the build material, wherein the first parked position is in an outer volume within the 3D printer that is to have lower operating temperature and lower operating concentration of build material than a volume near the build platform. The lower operating temperature and the lower concentration of build material may decrease the incidences of corruption or fouling of the print assembly or energy source as exposure to excess heat or building material may adversely affect the operation of the print assembly or energy source.

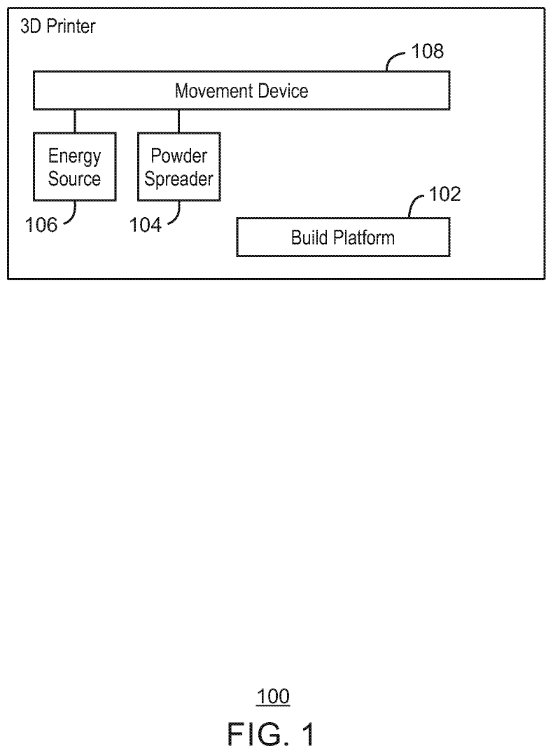

FIG. 1 is a 3D printer 100 having a build platform 102. In operation, the build platform 102 may receive build material for the 3D printer 100 to form a 3D object on the build platform 102. In certain examples, the build platform 102 may reside on a piston for the 3D printer to incrementally lower the build platform as the 3D object is formed layer-by-layer. The 3D printer 100 may have a build enclosure associated with the build platform 102.

Lastly, while FIG. 1 depicts the build platform 102, the printer 100 may be manufactured and sold without the build platform 102. For instance, in some examples an operationally-removable build unit may include the build platform. The build platform may be a removable unit or a fixed unit. As used herein, the reference to a build unit may refer to either a removable build unit or a fixed build unit including the components within and interacting with the build unit. The build unit may also include the build enclosure.

The 3D printer 100 may include a build-material applicator such as a powder spreader 104. The powder spreader 104 may distribute build material across the build platform 102. In an example, the powder spreader 104 may be or include a mechanical arm, a physical roller, a scraping tool or rake, or other form to apply the build material to an upper surface of the build platform. In certain examples, the powder spreader 104 may facilitate control of application of build material to the build platform.

In some examples, the 3D printer 100 provides the build material to the powder spreader 104 via an internal conveying system of the printer. The conveying system may receive build material made available by a material cartridge inserted into the 3D printer 100. The conveying system may transport the build material through an internal or integrated dispense vessel to the build-material applicator or powder spreader 104.

The 3D printer 100 includes an energy source 106 that moves over the build platform 102 to apply energy to build material on the build platform 102 to form the 3D object. The energy source 106 may be a light source or a heat source, or both. Thus, the energy may be light or heat, or both. In one example, the 3D printer 100 does not include a second energy source disposed static overhead in the 3D printer. Moreover, as discussed below, if the 3D printer 100 ejects print liquid onto the build material on the build platform 102, the 3D printer 100 may apply energy with the energy source 106 to the build material generally and thus to the print liquid ejected onto the build material. The print liquid may facilitate absorption of the energy into the portions of the build material where the print liquid is applied.

In the illustrated example, the 3D printer 100 includes a movement device 108 to carry the powder spreader 104 and the energy source 106 over the build platform 102. The powder spreader 104 and the energy source 106 may reside on the movement device 108, such as on a support, platform, or frame of the movement device. In some examples, the movement device 108 is a carriage. As indicated, the movement device 108 may have a frame to hold and support the powder spreader 104 and the energy source 106. The movement device 108 may include or be associated with a motor, belts, rails, wheels, etc. to provide for movement and positioning of the movement device 108. In certain examples, the movement device 108 may have a rest position away from the build platform 102. Moreover, in particular examples, the movement device 108 does not carry or position a print assembly that ejects print liquid onto the build material on the build platform 102.

The 3D printer 100 may include a second movement device to carry a print assembly over the build platform. The print assembly may eject print liquid onto selected portions of the build material on the build platform via positioning of the print assembly by the second movement device. As mentioned, the energy source 106 may apply energy to build material to form the 3D object. Thus, as the energy source 106 may apply energy to the build material generally uniformly, the energy source 106 may apply energy to the print liquid ejected onto the build material to form the 3D object. In some examples, the print assembly may be or includes a printbar having nozzles to eject the print liquid. The print assembly may include two or more printbars. In certain examples, the print liquid may be a fusing agent, detailing agent, coloring agent, color fusing agent, black agent, magenta agent, yellow agent, cyan agent, or other types of print liquid or printing agents. Moreover, in one example, the second movement device may move the print assembly parallel with a direction of movement of the first movement device. Such may provide for the respective default or rest positions of the movement devices to be relatively distant with respect to each other. Lastly, a selective solidification module or thermal fusion system of the 3D printer 100 may include the energy source 106, the movement device 108, the print assembly, the second movement device, and so on. The thermal fusion system may or may not incorporate the powder spreader 104.

Aspects of the discussion of FIG. 1 may also be applicable with the printer 100 as a selective laser sintering (SLS) printer, and the thermal fusion system is a selective solidification module performing, via applied energy (e.g., laser), selective layer sintering (SLS) or similar 3D printing technique. In other examples, the printer 100 is not an SLS printer, and the thermal fusion system performs, via applied energy and print liquid, fusion for selective solidification. Other configurations are applicable.

In operation, the 3D printer 100 may employ the energy source 106 to fuse build material on the build platform 102 to form a layer of a 3D object. The powder spreader 104 may disperse more build material across the surface of the build platform 102 for the next layer. The energy source 106 may fuse additional build material to form the next layer of the 3D object. The 3D printer may repeat these actions and continue until the 3D object is formed.

As indicated, the movement device 108 may carry and move the powder spreader 104 and the energy source 106 over and across the build platform 102. As mentioned for some examples, the movement device 108 can have a carriage, a servo actuated arm, belts, a guided track and gear, and so on. In particular examples, the movement device 108 may be driven via magnetism, an electrical field, or combustion. In an example, the movement device 108 as a carriage can include a guided track over and across the build platform 102 for holding the powder spreader 104 or the energy source 106, or both.

In an example, the movement device 108 does not carry a print assembly and, therefore, the energy source 106 may generally remain in a rest or default position away from the build platform when the energy source 106 is not applying energy to the build material and when the movement device 100 is not moving the powder spreader 104 to distribute build material across the build platform. In some examples, reducing the time duration the energy source 106 is over or near the build platform 102 may extend a time duration for the functioning life and capability of the energy source 106.

In an example, the energy source 106 can be a light source having a lens that aids in the application of light to the build material. Exposure of the energy source 106 to build material such as powder can reduce the functionality of the energy source 106 for at least the reason the powder may collect on the lens of the energy source 106 and obstruct the lens during the application of light or energy to the build material. Build material or powder obstructing the lens of the energy source 106 can lower the precision of the energy source or lower intensity of the energy applied by the energy source 106 to the build material. Lowering the accuracy or intensity of the energy source can adversely impact the solidification of a layer of the 3D object and quality of the formed 3D object. The build material may contaminate sensitive components of the energy source 106 other than a lens. In some examples, the energy source 106 does not have or employ a lens.

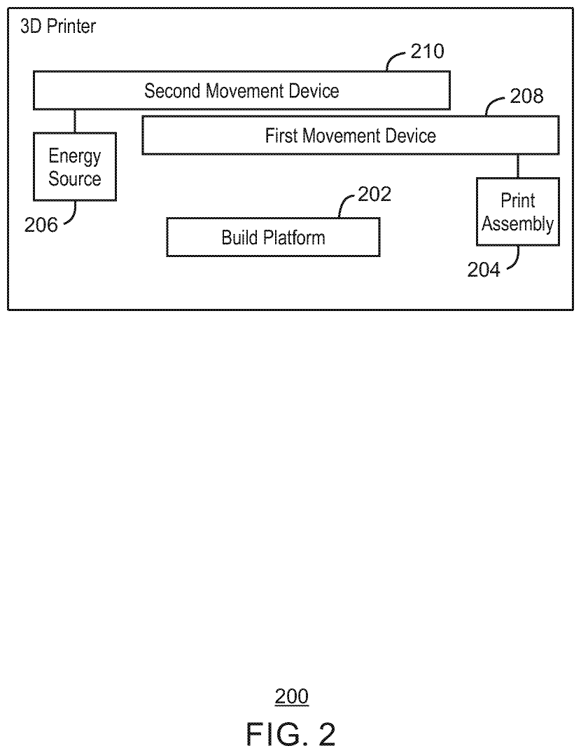

FIG. 2 is 3D printer 200 having a build platform 202 to receive build material. As discussed, the build platform 102 may receive build material for the 3D printer 100 to form a 3D object on the build platform 102. The 3D printer 200 may include a print assembly 204 to eject print liquid onto selected portions of the build material on the build platform 202. The print assembly 204 may include a print liquid applicator, a printbar, a pagewide printhead, or other print-agent applier. The print liquid ejected may be a detailing agent, a fusing agent, a texture agent, an elasticity agent, a color agent, an opacity agent, or a conductivity agent, and so on. In an example, the print assembly 204 may eject the print liquid through nozzles or jets disposed on a printhead or printbar.

Again, the 3D printer 200 may include an energy source 206. The energy source 206 may be a light source or a heat source. In an example, the energy source 206 may apply energy to the build material and, therefore, to the print liquid ejected onto the build material to form a 3D object on the build platform 202. As discussed, the 3D printer 200 may include a first movement device 208 to position the print assembly 204 over the build platform 202. The 3D printer may also include a second movement device 210 to move the energy source 206 over the build platform. The first movement device 208 and second movement device 210 may each include or be associated with a motor, belts, rails, wheels, etc. to provide for movement and positioning of the movement device 108.

In certain examples, the first movement device 108 and second movement device 210 may have respective rest positions away from each other and from the build platform 202. The print assembly 204 may eject print liquid onto the build material on the build platform 202. The energy source 206, such as a light source or a laser, may melt or fuse the material on the build platform 202 to form a layer of a 3D object.

The first movement device 208 and second movement device 210 may move separately from each other to guide the movement of the print assembly 204 and the energy source 206. As a result, the print assembly 204 and the energy source 206 may move independently over the build platform 202 and rest away each other. Moving the print assembly 204 separately from the energy source 206 may allow the print assembly 204 to remain in a rest position or default position away from the build platform 202 when or in response to the print assembly 204 not applying print liquid to the build material. Reducing the time duration the print assembly 204 is over or near the build platform 202 can extend a time duration for the functioning life and capability of the print assembly 204.

In an example, the print assembly 204 may include a printbar, printhead, a pagewide printhead, and the like. The print assembly 204 may eject the print liquid through nozzles or jets disposed on the printbar or printhead. As discussed, exposure of the print assembly 204 to build material such as powder emanating from the build platform 202 can reduce the functionality of the print assembly 204 because, for example, the powder may clog the nozzles.

Further, the build material on the build platform 202 can retain energy applied by the energy source 206 and radiate heat. The first movement device 208 moving the print assembly 204 away from the build platform 202 in response to the print assembly not ejecting print liquid can reduce the exposure of the print assembly 204 to heat radiated from the build material. Reducing exposure of the print assembly 204 to heat can lower occurrence of potential degrading effects of heat on print liquid in the print assembly 204.

Additionally, the first movement device 208 guides the movement of the print assembly 204 away from the energy source 206 when the print assembly 204 is not ejecting print liquid. The second movement device 210 guides the movement of the energy source 206 away from the print assembly 204 in response to the energy source 206 not needed above the build platform 202 to emit energy. The separation of the print assembly 204 and the energy source 206 may reduce exposure of the print assembly to residual heat from the energy source 206 radiating from the energy source 206.

As discussed, the second movement device 210 may move the energy source 206 in a path that is parallel with a direction of movement of the first movement device 208. The parallel path of movement may separate the print assembly 204 and the energy source 206 by a distance substantially equal to the width of the 3D printer 200, or at least 80% of the width of the printer 200.

As also discussed, the 3D printer 200 may include a powder spreader to place the build material across the build platform. The powder spreader may disperse build material for the successive layers for application of print liquid and energy. The second movement device 210 may include a carriage to move the powder spreader for dispersing build material and to move the energy source 206.

Lastly, the print assembly 204. e.g., printbar, may selectively eject (e.g., based on a 3D object model of the object to be generate) a print liquid, e.g., fusing agent, onto the build material on the build platform 202 for a layer of the 3D object. The energy source 206 via application of energy (e.g., light or heat) to the fusing agent may selectively fuse, or cause selective fusion of, the material on the build platform 202 to form a layer of the 3D object. The powder spreader or other build-material applicator may disperse more material across the surface of the build platform 202 to form the next layer. The printbar may eject further fusing agent onto the material on the build platform 202 and the energy source 206 may apply energy to form the next layer. Indeed, the additional material may be selectively fused to form the next layer of the 3D object. This repeated dispersion of build material onto the build platform 202 and ejection of fusing agent onto the build material on the build platform 202 (and application of energy) may continue for successive layers until the 3D object is, for example, completely formed or substantially-completely formed. In certain examples, as discussed below, the printbar and the energy source, may be components of the thermal fusion system. In some examples, the thermal fusion system, as well as the powder spreader or build-material applicator, may be disposed at least partially above the build enclosure and the build platform 202.

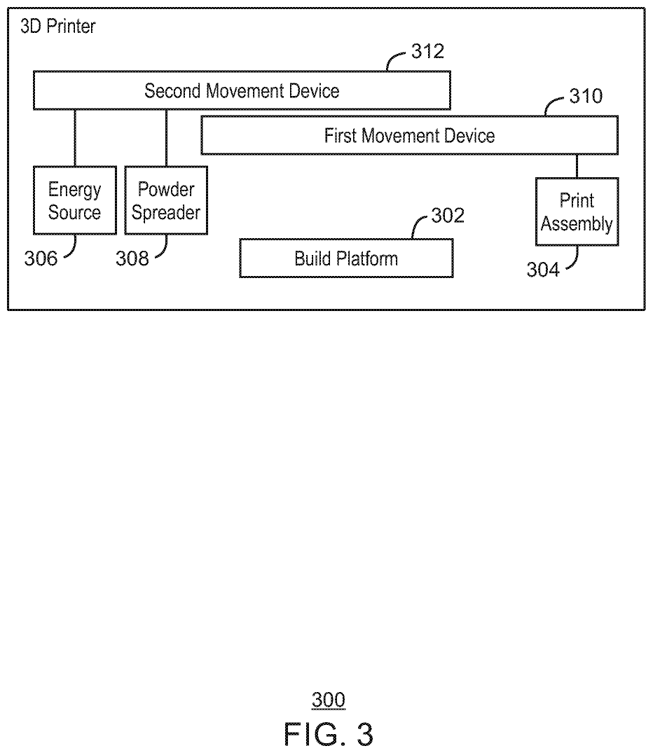

FIG. 3 is a 3D printer 300 having a build platform 302 to receive deposited build material one layer at a time. The 3D printer 300 may include a print assembly 304, an energy source 306, and a powder spreader 308. In the illustrated example, the 3D printer 300 includes a first movement device 310 to carry and move the print assembly 304 over and across the build platform 302. The 3D printer 300 may include a second movement device 312 to carry and move the energy source 306 and the powder spreader 308 over and across the build platform 302.

Again, the first movement device 310 may carry and move the print assembly 304 over and across the build platform 302. The second movement device 312 may carry and move the energy source 306 over and across the build platform 302. The first movement device 310, which is separate from the second movement device and the energy source 306, moves and guides the movement of the print assembly 304 away from the powder spreader 308 in response to the print assembly 304 concluding printing (e.g., concluding ejecting of print liquid) for the current layer of the 3D object. The separation of the print assembly 304 and the powder spreader 308 reduces exposure of the print assembly to residual powder on the powder spreader 308. The residual powder on the powder spreader 308 may be powder collected on the powder spreader 308 during the spreading of build material powder across the build platform 302. Reducing exposure of the print assembly to stray or loose powder reduces the potential for jets of the print assembly to become clogged with the powder.

As mentioned, a selective solidification module or thermal fusion module may selectively solidify or fuse portions of successive layers of a build material on the build platform 302. The thermal fusion module may include the aforementioned movement devices, energy source, print assembly, and so on. The thermal fusion module may be adjacent (e.g., above) or at least partially over a build enclosure associated with the build platform 302. As also mentioned, together, the build enclosure and the build platform 302 may constitute a build unit.

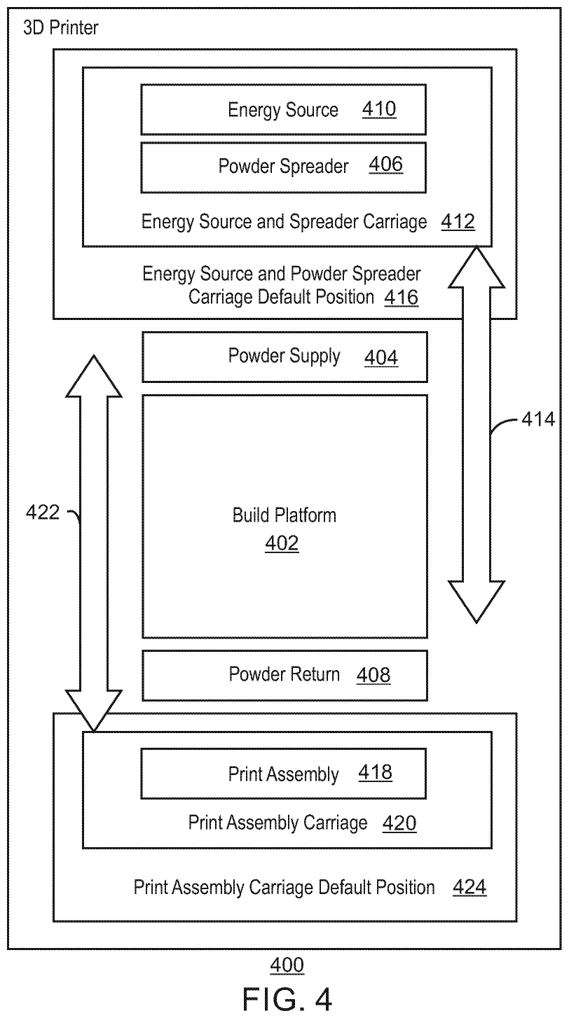

FIG. 4 is 3D printer 400 including a build platform 402. While the objects shown are intended to be figurative representations of physical objects, relative locations, and action, FIG. 4 provides a representation top view of an example organization of these components. The 3D printer 400 may selectively solidify or fuse portions of successive layers of a build material on the build platform 402. The 3D printer 400 may dispense build material along a powder supply surface 404 adjacent to the build platform 402 for the build material to be dispersed or spread by a powder spreader 406 over the build platform 402. The 3D printer 400 may employ types of build-material applicators other than the powder spreader 406 to distribute and control the location of material applied to the build platform 402. In some examples, the powder spreader 406 may displace excess powder exceeding a current layer of build material on the build platform 402 to a powder return 408. The 3D printer 400 may reclaim or recycle powder sent to the powder return 408 for future application. The powder spreader 406 may disperse or spread the build material across the build platform 402 one layer at a time.

The 3D printer 400 includes a first carriage 412 for the powder spreader 406 and an energy source 410. The energy-source and powder-spreader carriage 412 can carry and move the energy source 410 and the powder spreader 406 over and across the build platform 402 in a first movement direction 414. The first movement direction 414 may move the energy source 410 and the powder spreader 406 over and across the build platform 402, and then back to an energy-source and powder-spreader carriage-default position 416 which may be a location away from the build platform 402. This location away from the build platform may reduce exposure of the energy source 410 to the build material from the build platform 402. As discussed, build material such as powder may occlude a lens or output area of the energy source and reduce functionality of the energy source 410.

The 3D printer 400 may include a print assembly 418 to eject print liquid onto build material on the build platform 402. The print assembly 418 may include a printbar, printhead, print nozzles, and so on. As discussed, the print liquid ejected may be a fusing agent and various other printing agents. In an example, the print assembly 418 may eject the print liquid through ejection nozzles or jets disposed on dies or printheads of a printbar.

The 3D printer 400 includes a print assembly carriage 420. In an example, the print assembly carriage 420 can include a guided track over and across a build platform 402 and a pen for holding the print assembly 418. The print assembly carriage 420 may carry and move the print assembly 418 over and across the build platform 402 in a second movement direction 422. The second movement direction 422 may move the print assembly 418 over and across the build platform then back to a default position 424 of the print assembly carriage. The default position 424 of the print assembly carriage may be a location away from the build platform 402. The location of the default position 424 away from the build platform 402 may reduce exposure of the print assembly 418 to the build material of the build platform 402. As discussed, build material such as powder, may clog nozzles or jets of the print assembly. Further, residual heat radiating from the build material may degrade print liquid held in the print assembly 418. Residual heating may also degrade or damage print assembly 418 hardware. For example, there are components within a printbar that could warp under high heat, and so on.

In an example, the first movement direction 414 for the energy-source and powder-spreader carriage 412 can be parallel or substantially parallel to the second movement direction 422 of the print assembly carriage 420. As the first movement direction 414 and the second movement direction 422 are parallel or substantially parallel in this example, the print assembly 418 and the powder spreader 406 may be kept relatively far apart when at rest. As discussed, increased distance between the print assembly 418 and the powder spreader 406 may reduce the probability of loose or residual powder on the powder spreader 406 from clogging the jets of the print assembly 418. The parallel nature of the first movement direction 414 and the second movement direction 422 may facilitate the print assembly 418 and the energy source 410 may be kept far apart (e.g., nearly as far apart as possible or feasible) when not disposed over the build platform 402. As discussed, increasing the distance between the print assembly 418 and the energy source 410 may reduce the probability of heat from the energy source degrading the print liquid held in the print assembly 418, or damaging or warping hardware such as a printbar of the print assembly 418.

In some examples, the print assembly 418 and the energy source 410 may be on the same carriage opposite the powder spreader 406. Moreover, in particular examples, the movement paths 414, 422 of the print assembly and the powder spreader, respectively, may be orthogonal to each other to reduce the overlap of the path of the print assembly 418 and the powder spreader 406 in examples. Orthogonal movement paths of the print assembly 418 and the powder spreader 406 may reduce exposure of the print assembly 418 to free or residual powder from the powder spreader 406.

In an example where the powder spreader 406, the energy source 410, and print assembly 418 are moved as shown in FIG. 4, the movement may follow an ordered sequence. First, the energy-source and powder-spreader carriage 412 may move the powder spreader 406 to spread a layer of build material across the build platform 402. Second, the energy-source and powder-spreader carriage 412 may return to the energy-source and powder-spreader carriage-default position 416 while the print assembly 418 is moved by the print assembly carriage 420 to eject print liquid onto the build material. Third, the print assembly carriage 420 may retreat to the print-assembly carriage-default position 424. As the print assembly carriage 420 retreats, the energy-source and powder-spreader carriage 412 may advance towards the build platform and the energy source 410 may apply a first pass of energy to fuse build material on the build platform 402. Fourth, the energy-source and powder-spreader carriage 412 may retreat to the energy-source and powder-spreader carriage-default position 416. As the energy-source and power-spreader carriage 412 retreats, the energy source 410 may perform a second pass of energy to fuse build material on the build platform 402. Lastly, the 3D printer 400 may provide build material into a path of the powder spreader 406 for the next layer. The cycle may begin again, as the powder spreader 406 advances over and across the build platform 402 to spread build material for the next layer of printing.

While an ordered sequence is provided, other ordered sequences may also be followed. Sequencing can follow material spreading, material warming, printing ejection, and material fusing phases. A spread pass may refer to a phase of action for a powder-spreader to disperse build material across the build platform. A warm pass may refer to a phase of action for an energy source applies energy insufficient to fuse material but sufficient to warm the material closer to a fusing temperature of the material. A print ejecting or print pass may refer to a phase of action for a print assembly to eject print liquid onto material on the build platform. A fusing pass may refer to a phase of action for an energy source applying energy sufficient to fuse a layer of material.

An example of an ordered sequence may include multiple phases such as phase 1, 2, or 3 to indicate an order of the phase in a complete cycle for of material spreading, warming, printing, and fusing. First, for instance, a 3D printer may execute fuse pass 3, if a previous layer on the build platform is present, combined with a spread pass 1 and a warm pass 1. This first sequence may include an energy source and spreader carriage 412 moving across the build platform while the print carriage is parked in the print assembly carriage default position 424 away from the build platform. Second, a 3D printer may execute a spread pass 2, warm pass 2, print pass 1. During these phases, the energy source and spreader carriage 412 may return towards the energy source and spreader carriage default position 416 away from the build platform 402 and may be followed by print carriage 420. Third, a 3D printer may execute a print pass 2, fuse pass 1, warm pass 3. During these phases, both the energy source and spreader carriage 412 and the print assembly carriage 420 move the same direction such that the energy source and spreader carriage 412 moves towards and over the build platform 402 while the print carriage moves away from the build platform 402. Fourth, a 3D printer may execute warm pass 4 and fuse pass 2. During these phases, an energy source and spreader carriage 412 scans away from the build platform 402 and the print carriage stays parked in the print assembly carriage default position 424.

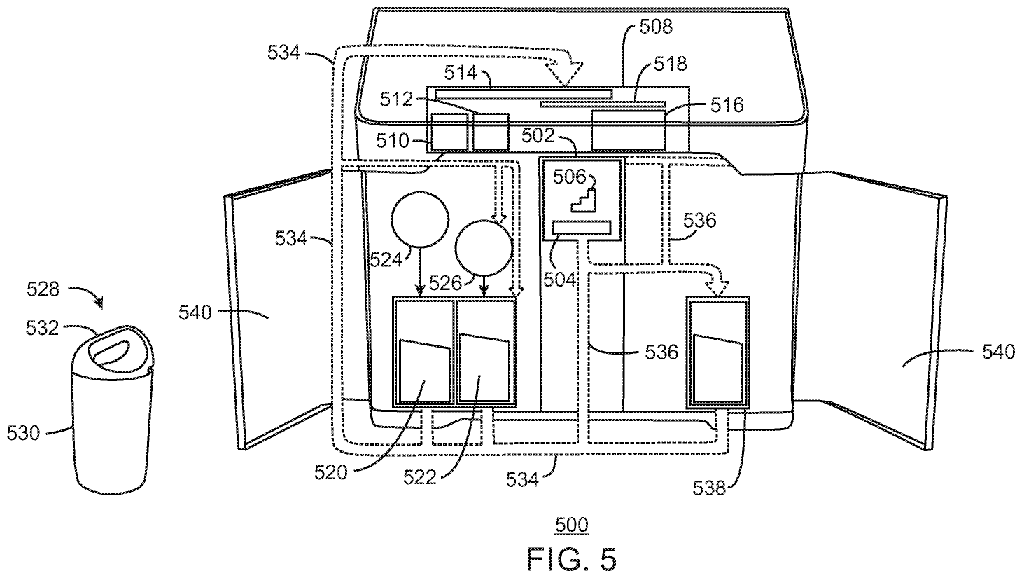

FIG. 5 is a 3D printer 500 including a build enclosure 502 which may be associated with a build platform 504 on which a 3D object 506 is formed from feed material. The feed material or build material may be composed of new material and recycle material, and other material. The build enclosure 502 may be a build bucket, build chamber, build container, or build housing, or the like.

The printer 500 may include a thermal fusion system 508 to selectively solidify or fuse successive layers of build material on the build platform 504 to form the 3D object 506. For example, the thermal fusion system 508 may include an energy source 510 such as a heat source, light source, radiation source, infrared light source, near infrared light source, heat lamps, etc. The thermal fusion system 508 may solidify the build material through the application on energy from the energy source 510 to the build material on the build platform 504 to melt or fuse the build material to form the 3D object 506. In particular, the energy source 510 may apply energy to print liquid ejected onto selected portions of the build material on the build platform 504.

The thermal fusion system 508 may include a build-material applicator 512. On the other hand, the build-material applicator 512 may be a component not of the thermal fusion system 508. In operation, the build-material applicator 512 may distribute feed material or build material across the top or upper surface of the build platform 504. The build material applicator may be disposed at an upper portion of the printer 500 above the build enclosure 502. Examples of a build-material applicator 512 include a powder spreader, powder spreader arm, a powder spreader roller, or other type of applicator.

In a particular example, the build-material applicator 512 may receive build material from an internal conveying system through a dispense vessel and a feed apparatus such as a dosing device. Further, in some examples, the build-material applicator 512 may reside on and/or be moved by a first carriage 514 in the thermal fusion system 508. The energy source 510 may reside on and/or be moved by the first carriage 514 with or without the build-material applicator 512. When the energy source is not emitting energy to form the 3D object, the first carriage 514 may move to a default energy-source position to store the energy source 510 away from the build platform 504 to reduce the exposure of the energy source 510 to build material that may impede the function of the energy source 510. In an example, the build material may impede function of the energy source 510 through fouling of a lens of the energy source 510. The occlusion of the lens through which energy passes may reduce the heating ability, consistency, or accuracy of the energy source 510.

The thermal fusion system 508 may also have a print assembly 516. The print assembly 516 may include a printbar or pagewide printhead, or other component to eject print liquid. The print assembly could include a number of printbars, or pagewide printheads, and the like. The print assembly 516 may reside on and/or be moved by the second carriage 518 separate from the first carriage 514 and the build-material applicator 512. In an example, the print assembly 516 may be moved and disposed away from the build-material applicator 512 to reduce exposure of the print assembly to stray build material from the build-material applicator 512. For example, if the build material applicator 512 is a powder spreader, some of the powder may be inadvertently displaced along the path of the powder spreader and to components near the powder spreader. In this example, the print assembly 516 may reduce or avoid clogging of print nozzles or jets by residing on the second carriage 518. By residing on the second carriage 518, the print assembly may position print nozzles or jets away from potentially clogging free or emanating powder.

Because the print assembly 516 is not moved by the first carriage 514, the print assembly 516 may be stored in a rest or default print-assembly position away from the build platform when the print assembly is not ejecting print liquid. Thus, exposure of the print assembly 516 to build material that may impede the function of the print assembly 516 may be reduced. For example, the residual heat radiating from the build material on the build platform 504 may impede the print assembly function by degrading the composition of a print liquid or other agent that a print assembly 516 may eject. Also, extended exposure to heat from the build material may also degrade or damage the print assembly 516 hardware. For example, as mentioned, there are components within the printbar that could warp under relatively high heat. Further, exposure of the print assembly 516 to build material disposed on the build platform when the print assembly 516 is over the build platform 504 can lead to clogging of ejection jets of the print assembly 516.

To store build material, the 3D printer 500 in some examples may include a new material vessel 520 to receive new material from a new material cartridge held by a new cartridge receiver 524. A recycle material vessel 522 may receive recycle material from a recycle material cartridge held by a recycle cartridge receiver 526. The new material and recycle material as build material may be gravity fed or otherwise conveyed to the new material vessel 520 and the recycle material vessel 522, respectively. The cartridge receivers 524 and 526 may be a cavity, receptacle, slot, sleeve, or any combinations thereof. The material cartridges may each be an enclosure to contain build material. The material or build material may be metal, plastic, polymer, glass, ceramic, or other material.

The 3D printer 500 may feed new material and recycle material to the build enclosure 502 at a specified ratio of new material to recycle material for printing of the 3D object 506. The ratio may be a weight ratio, volume ratio, or other ratio. The ratio may range from zero, e.g., no new material, all recycle material, to 1.0, e.g., all new material, no recycle material. For example, the ratio as a weight ratio or volume ratio may range from 0.01 to 0.99, 0.05 to 0.95, 0.1 to 0.9, 0.15 to 0.85, 0.2 to 0.8, 0.25 to 0.75, 0.3 to 0.7, etc. In one example, the feed material to the build enclosure 502 may be 20% new material and 80% recycle material based on weight, yielding a weight ratio of 0.25. In another example, the feed material to the build enclosure 502 may be 20% new material and 80% recycle material based on volume, yielding a volume ratio of 0.25.

A material cartridge 528 may have new material, recycle material, or is empty prior to insertion to the printer 500. The material cartridge 528 may be inserted into the new material cartridge receiver 524 or the recycle cartridge receiver 526. The cartridge 528 as depicted is only an example, and may include a container or housing 530 to contain or hold material such as new material or recycle material. In particular examples, the material cartridge 528 has a handle 532 to facilitate user-lifting of the material cartridge 528 and user-insertion of the cartridge 528 into the receivers 524 or 526. In one example, the handle 532 may also facilitate the user to rotate the cartridge 528 when inserting the cartridge 528 into the new material cartridge receiver 524 or the recycle material cartridge receiver 526 to secure the cartridge 528 in the new material cartridge receiver 524 or the recycle material cartridge receiver 526.

Further, the printer 500 may include a conveying system 534 to transport new material and recycle material. The conveyance system 534 may include a pneumatic conveyance system, a mechanical conveying system, a vacuum system, gravity conveying, vibration conveying, belt conveying system, auger system, and so forth, or any combinations thereof. In the illustrated example, the new material from the new material vessel 520 and the recycle material from the recycle material vessel 522 may discharge into the conveying system 534, such as to a conduit of the conveying system 534. The new material and recycle material may progress upward, via the conveying system 534, through the 3D printer 500 towards the thermal fusion system 508. In certain examples, the new material and the recycle material may intermingle and mix in-line as the new material and the recycle material move through the conveyance system 534.

The printer 500 may include a second conveying system 536 to recover build material from the build enclosure 502. In some examples, the second conveying system 536 as a pneumatic conveyance system or vacuum system applies a vacuum to pull spill-over or excess build material from the build enclosure 502. In a particular example, the second conveying system 536 includes a conduit manifold at a bottom portion of the build enclosure 502 to receive build material from the build enclosure 502 via the vacuum after generation of a 3D object has completed. In one example, the manifold may be labeled as a perimeter vacuum. In the illustrated example, excess build material may be conveyed, via the second conveying system 536, from the build enclosure 502 to the reclaim vessel 538 or other destination.

Indeed, the 3D printer 500 may have a reclaim vessel 538 to recover material from, for example, the build enclosure 502 and the build platform 504. The material so recovered may be classified as 100% recycle material, or instead classified as reclaim material having the specified ratio of recycle material to new material. Other classifications are applicable. In the first instance with the recovered material classified as 100% recycle material, the reclaim vessel 538 may be labeled or characterized as a second recycle vessel in the illustrated example. Moreover, the reclaim vessel 538 may provide residence time for the recycle material or reclaim material to cool. The material recovered and stored in the reclaim vessel 538 may be returned to the build platform 504 during the current print job or a subsequent print job. Material in the reclaim vessel 538 may be transported by the conveying system 534 to the thermal fusion system 508, to a recycle cartridge in the recycle cartridge receiver 526, or to the recycle material vessel 522, and so on.

The 3D printer 500 is shown with the printer outside housing or casing having front access panels 540. A portion of an interior of the printer 500 is visible. These access panels 540 may close to conceal and further protect components of the 3D printer 500. Components inside or partially inside the outer housing of the 3D printer, including inside the access panels 540, can be considered integrated within the 3D printer 500 in certain examples.

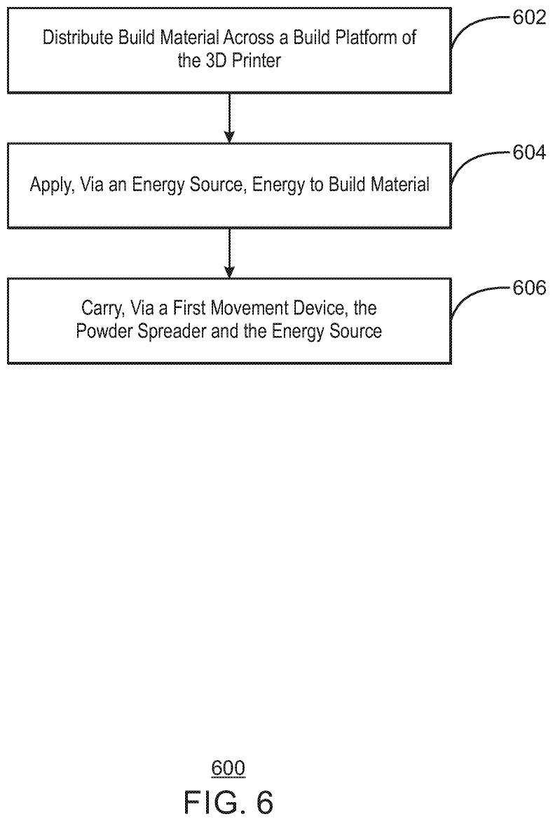

FIG. 6 is a block flow diagram of a method 600 of operating a 3D printer in accordance with examples of the present techniques. At block 602, the method 600 includes distributing, via a powder spreader, build material across a build platform of the 3D printer. In an example, the build material may be provided to the powder spreader via an internal conveying system.

At block 604, the method 600 includes applying, via an energy source, energy to build material on the build platform to form a 3D object on the build platform. In an example, the energy source includes a light source or a heat source.

At block 606, the method 600 includes carrying, via a first movement device, the powder spreader and the energy source. In an example, the first movement device includes a carriage, and wherein the 3D printer does not include another energy source that is disposed static overhead in the 3D printer. In an example, the first movement device does not carry or position a print assembly that ejects print liquid onto the build material. The method 600 can be implemented by a 3D printer that includes a print assembly with a printbar having nozzles to eject print liquid, where the print liquid includes a fusing agent or other type of printing agent.

In an example, a 3D printer implementing method 600 may include a second movement device to carry a print assembly over the build platform. The print assembly may eject print liquid onto selected portions of the build material on the build platform via positioning of the print assembly by the second movement device. The energy source may apply energy to the print liquid ejected onto the build material to form a 3D object. In an example, the second movement device may move the print assembly parallel with a direction of movement of the movement device.

Again, the 3D object may be printed from feed material composed of new material and recycle material. The feed material may have a specified weight ratio or volume ratio of new material to recycle material in a range from zero to 1.0. For example, the weight ratio may range from 0.01 to 0.99, 0.05 to 0.95, 0.1 to 0.9, 0.15 to 0.85, 0.2 to 0.8, 0.25 to 0.75, 0.3 to 0.7, etc. The new material may be provided by a new material cartridge receiver having a new material cartridge in the 3D printer. Alternatively, or in addition, a new material vessel may store and provide the new material. In some examples, the new material vessel, if employed, may be disposed below the new material cartridge, and the new material vessel supplied by the new material cartridge.

In 3D printers having a new material vessel and a recycle material vessel, the new material and the recycle material may be conveyed from the new material vessel and the recycle material vessel, respectively, to a build enclosure for printing of a 3D object. The new material and the recycle material may mix in-line as being conveyed to the build enclosure as feed material having the specified or desired ratio of new material to recycle material. Again, the ratio may be a weight ratio, volume ratio, or other ratio. Moreover, instead of being fed directly to the build enclosure, the feed material may be conveyed through a dispense vessel to a build-material applicator or thermal fusion module above the build enclosure. In some examples, the dispense vessel may supply feed material to the build enclosure via the build-material applicator such as a powder spreader or powder spreader arm.

In addition, the techniques described herein may facilitate handling of recycle material. Removable material cartridges may be inserted into the 3D printer. Recycle material within a 3D printer may be loaded into cartridges and then removed and stored for future application. Material from a cartridge may be supplied to the 3D printer.

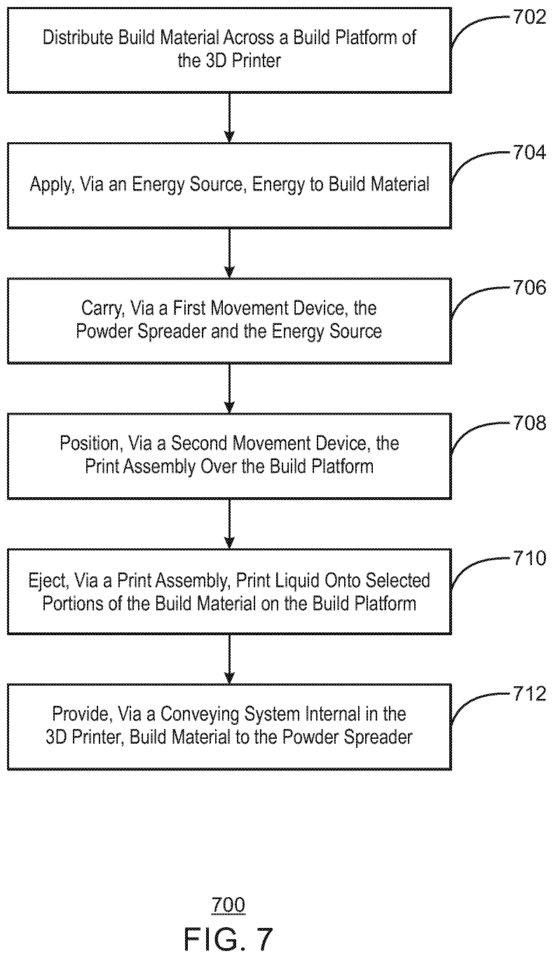

FIG. 7 is a block flow diagram of a method 700 of operating a 3D printer in accordance with examples of the present techniques. At block 702, the method 700 includes distributing, via a powder spreader, build material across a build platform of the 3D printer. In an example, the build material may be provided to the powder spreader via an internal conveying system.

At block 704, the method 700 includes applying, via an energy source, energy to build material on the build platform to form a 3D object on the build platform. In an example, the energy source includes a light source or a heat source.

At block 706, the method 700 includes carrying, via a first movement device, the powder spreader and the energy source. The first movement device may include a carriage. In an example, the 3D printer does not include another energy source that is disposed static overhead in the 3D printer. In an example, the first movement device does not carry or position a print assembly that ejects print liquid onto the build material.

At block 708, the method 700 includes positioning, via a second movement device, the print assembly over the build platform. The second movement device may position the print assembly over the build platform as long as the print assembly needs to operate. In an example, the print assembly may move over build platform solely to eject print liquid and at no other time.

At block 710, the method 700 includes ejecting, via a print assembly, print liquid onto selected portions of the build material on the build platform to form the 3D object on the build platform. As discussed, the print assembly may return from the position over the build platform as soon as the print assembly is no longer ejecting print liquid. Ejecting print liquid onto selected portions of the build material may provide for increased heat transfer from an energy source to selected portions of the build material wherein the print liquid is applied.

At block 712, the method 700 includes providing, via a conveying system internal in the 3D printer, build material to the powder spreader. The conveying system may provide the build material. The conveying system may be a pneumatic conveyance system. The conveying system may be an integrated conveying system as a component of the printer, including internal to the printer such as completely or partially within the 3D printer.

In an example, the print assembly may include a printbar having nozzles to eject print liquid, and wherein the print liquid includes fusing agent or other type of printing agent. As discussed, a 3D printer implementing method 700 may include a second movement device to carry a print assembly over the build platform. The print assembly may eject print liquid onto selected portions of the build material on the build platform via positioning of the print assembly by the second movement device. The energy source may apply energy to the print liquid ejected onto the build material to form a 3D object. In an example, the second movement device may move the print assembly parallel with a direction of movement of the powder spreader and the energy source.

While the present techniques may be susceptible to various modifications and alternative forms, the examples discussed above are shown by way of example. It is to be understood that the technique is not intended to be limited to the particular examples disclosed herein. Indeed, the present techniques include all alternatives, modifications, and equivalents falling within the scope of the present techniques.

What is claimed is:

1. A three-dimensional (3D) printer comprising:
a print assembly to eject print liquid onto selected portions of build material on a build platform;
an energy source to apply energy to the build material on the build platform to form a 3D object from the build material; and
a first movement device to position the print assembly over the build platform to eject the print liquid, wherein the first movement device is to rest in a first parked position away from the build platform to reduce exposure of the print assembly to the build material, wherein the first parked position is out of direct line of sight of an overhead heating lamp.

2. The 3D printer of claim 1, wherein the first movement device to place the print assembly in the first parked position in response to the print assembly not being in use, wherein the first park position is at an edge region of the 3D printer, and wherein the energy source does not reside on the first movement device.

3. The 3D printer of claim 2, comprising a second movement device to carry the energy source to apply the energy to the build material on the build platform, wherein the second movement device is to rest in a second parked position at an opposite edge region of the 3D printer as compared to the edge region of the first parked position.

4. The 3D printer of claim 3, comprising a powder spreader to distribute build material across the build platform, wherein the second movement device is to carry the powder spreader across the build platform for the powder spreader to distribute the build material.

5. The 3D printer of claim 4, comprising an internal conveying system to provide build material for the powder spreader, wherein the print assembly comprises a printbar having nozzles to eject print liquid, and wherein the print liquid comprises a fusing agent.

6. The 3D printer of claim 3, wherein the first movement device comprises a carriage, and wherein the 3D printer does not comprise another energy source that is disposed static overhead in the 3D printer.

7. The 3D printer of claim 1, comprising the build platform, wherein the energy source comprises a light source or a heat source, wherein the first movement device to place the print assembly in the first parked position in response to the print assembly completing a pass over the build platform to eject the print liquid, and wherein the first movement device does not carry or position the energy source.

8. A three-dimensional (3D) printer comprising:
a print assembly to eject print liquid onto selected portions of build material on a build platform;
an energy source to apply energy to the build material and the print liquid ejected onto the build material to form a 3D object on the build platform;
a first movement device to carry and position the print assembly over the build platform, wherein the first movement device to rest in a first parked position away from the build platform and from the energy source; and
a second movement device to carry the energy source over the build platform.

9. The 3D printer of claim 8, wherein the second movement device comprises a second parked position at an opposite end portion of the 3D printer than the parked position of the first movement device.

10. The 3D printer of claim 8, comprising a powder spreader to disperse the build material across the build platform, wherein the second movement device comprises a carriage to move the powder spreader.

11. The 3D printer of claim 8, comprising the build platform to receive the build material, wherein the first parked position is in an outer volume within the 3D printer that is to have lower operating temperature and lower operating concentration of build material than a volume near the build platform.

12. A method of operating a three-dimensional (3D) printer, comprising:
positioning, via a first movement device, a print assembly over a build platform;
ejecting, via the print assembly, print liquid onto selected portions of build material on the build platform;
resting the first movement device in a first parked position to reduce exposure of the print assembly to the build material; and
applying, via the energy source, energy to build material on the build platform to form a 3D object on the build platform.

13. The method of claim 12, wherein the first parked position is at an edge portion of the 3D printer, and wherein applying energy comprises moving the energy source over the build platform via a second movement device.

14. The method of claim 13, comprising distributing build material across the build platform via a powder spreader residing on the second movement device.

15. The method of claim 14, comprising resting the second movement device in a second parked position at an opposite edge portion compared to the first parked position, wherein the first movement device comprises a first carriage and the second movement device comprises a second carriage, wherein the energy comprises light or heat, or both.
